(19) United States
(12) Patent Application Publication
(10) Pub. No.: US 2014/0120034 A1
(43) Pub. Date: May 1, 2014

(54) Zeolite Catalyst for Converting Oxygen-Containing Compound into Hydrocarbon

(71) Applicant: Atomic Energy Council-Institute of Nuclear Research, (US)

(72) Inventors: Kuo-Chao Liang, Chiayi County (TW); Feng-Mei Ye, Taoyuan County (TW); How-Ming Lee, Taoyuan County (TW); Chin-Ching Tzeng, New Taipei City (TW)

(73) Assignee: Atomic Energy Council-Institute of Nuclear Research, Taoyuan County (TW)

(21) Appl. No.: 13/758,496

(22) Filed: Feb. 4, 2013

(30) Foreign Application Priority Data
Oct. 30, 2012 (TW) 101140215

(51) Int. Cl. C10G 3/00; B01J 29/04

(52) U.S. Cl. CPC C10G 3/49; B01J 29/04
USPC 423/700

(57) ABSTRACT

A catalyst is provided for converting oxygen-containing hydrocarbon into gasoline. The catalyst is made of an ammonium-ion zeolite. The oxygen-containing hydrocarbon is dehydrated with the catalyst to be converted into gasoline. The pH value of the catalyst is changed by a heat process. The catalyst which is carbon-deposited is reactivated through oxidation. Thus, life time of the catalyst is prolonged for the conversion.

### TECHNICAL FIELD OF THE INVENTION

The present invention relates to converting oxygen-containing compound into hydrocarbon; more particularly, relates to using an ammonium form zeolite as a catalyst to convert oxygen-containing compound into gasoline through dehydration while lifetime of the catalyst is prolonged for the conversion.

### DESCRIPTION OF THE RELATED ARTS

Generally, the zeolite is made by the hydrothermal crystallization through the solution of sodium aluminate, sodium silicate, sodium hydroxide, etc. then replacing their sodium ions with ammonium ions for further processing. Because the zeolites are widely used in petrochemical procedures and the structures and acidities of the zeolites are crucial to their applications. The acidity of the zeolite can be modified by adjusting the content ratios of silicon to aluminum or replacing different cation ions through ion exchange.

A technology of converting methanol into gasoline uses a ZSM-5 zeolite, which has pores to allow passing of hydrocarbons having sizes smaller than C₁₁hydrocarbon molecule only and has solid acid sites on its surface for transforming methanol into gasoline where hydrocarbon is obtained through dehydration. However, if the acidity of the zeolite is too strong, solid carbon may be easily deposited on its surface to deactivate catalyst; or, if the acidity of the zeolite is too weak, the reaction rate is slowed down and lifetime of the zeolite is shortened. Besides, ZSM-5 is usually transformed into a hydrogen form zeolite (H-ZSM-5), where a synthesized ammonium zeolite (NH₄-ZSM-5) is calcined at the air environment and cation ion exchange is processed with different metal-ion solutions to obtain the zeolite with the different metal-ion form. Yet, this procedure is complex and water-intensive. Furthermore, environment pollution may be found if wasted water is not properly handled.

Hence, the prior arts do not fulfill all users' requests on actual use.

### SUMMARY OF THE INVENTION

The present invention relates to converting oxygen-containing compound into hydrocarbon; more particularly, relates to using an ammonium form zeolite as a catalyst to convert oxygen-containing compound into gasoline through dehydration while lifetime of the catalyst is prolonged for the conversion through a thermo-process which changes the distribution of strong-acidic and weak-acidic sites of the ammonium form zeolite.

To achieve the above purpose, the present invention is a zeolite catalyst for converting oxygen-containing compound into hydrocarbon, comprising steps of: (a) filling an ammonium form zeolite to a reactor; directing air or nitrogen gas to pressure the reactor, increasing a temperature of the reactor to a certain temperature, converting the ammonium ions at weak-acid sites to form hydrogen ions to modify the acidity and activating the catalyst, and using the catalyst to dehydrate an oxygen-containing compound into a hydrocarbon; and (b) regenerating the catalyst through reactivating the catalyst by flowing an oxidizing gas to remove carbon deposits through oxidation at a high temperature. Accordingly, a novel zeolite catalyst for converting oxygen-containing compound into hydrocarbon is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the view showing step (a) of the preferred embodiment according to the present invention;

FIG. 2 is the view showing step (a) of the preferred embodiment;

FIG. 3 is the view showing the NH₃-TPD diagram of the ZSM-5 zeolite; and

FIG. 4 is the view showing the results of converting

DME into gasoline with H-ZSM-5, NH₄-ZSM-5 and ZSM-5.

### DESCRIPTION OF THE PREFERRED EMBODIMENT

The following description of the preferred embodiment is provided to understand the features and the structures of the present invention.

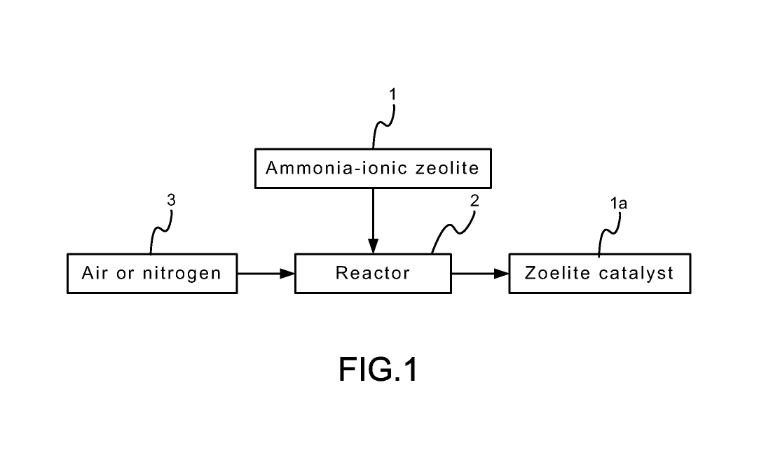

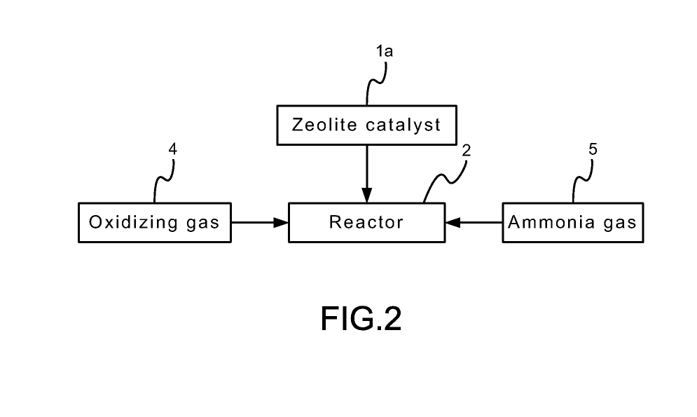

Please refer to FIG. 1 to FIG. 4, which are a view showing step (a) of the preferred embodiment according to the present invention; views showing step (a) and step (b) of the preferred embodiment; a view showing an NH₃-temperature-programmed desorption (NH₃-TPD) diagram of a ZSM-5 zeolite; and a view showing results of converting DME into gasoline with H-ZSM-5, NH₄-ZSM-5 and ZSM-5 prepared by our method. As shown in the figures, the present invention is a zeolite catalyst for converting oxygen-containing compound into hydrocarbon, comprising the following steps:

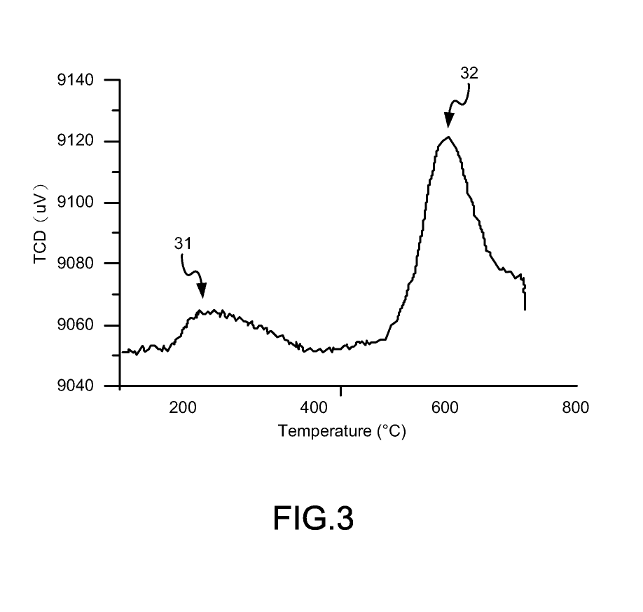

(a) An ammonium form zeolite 2 is filled into a reactor 2. Air or nitrogen gas 3 is directed to pressure the reactor 2 for 0˜10 bar, where the air or nitrogen gas 3 is kept at a gas hour space velocity (GHSV) of 0-20 liters of gas per gram of zeolite (l_gas/g_zeolite). Temperature of the reactor 2 is increased into a proper range. (As in the NH₃-TPD diagram in FIG. 3, the first peak value 31 is for a weak-acidic desorption and the second peak value 32 is for a strong-acidic desorption. The temperature of the reactor 2 should be higher than that of the weak-acidic desorption 31 and lower than that of the strong-acidic desorption 32.) After 0.1-48 hours (hrs), the ammonium form zeolites 1 at weak-acid sites are deammoniated to form hydrogen ions and thus a catalyst 1a is obtained. The catalyst 1a is modified with its acidity and is activated for dehydrating oxygen-containing compound into hydrocarbon.

(b) When the surface of the catalyst loses activity owing to carbon deposits, the catalyst 1a is regenerated. After the catalyst 1a is put into the reactor 2, an oxidizing gas 4 (like oxygen or air) is flown in to remove the carbon deposits of the catalyst 1a through oxidation at a proper temperature. When the temperature for regenerating the catalyst 1a is lower than a temperature of the strong-acidic desorption, the catalyst 1a is directly dehydrated again after regenerating the catalyst 1a. When the temperature of the catalyst 1a for the oxidation is higher than the temperature of the strong-acidic desorption, the ammonium ions at strong-acid sites are decomposed and dispersed; and, after an ammonia gas 5 is introduced (at a GHSV of 0.1˜1 l_gas/g_zeolite, a concentration of 1-10 weight percents (wt %) and flown in for 0.1˜24hrs) to be absorbed by the catalyst 1a after regenerating the catalyst 1a, the catalyst 1a is reactivated through step (a).

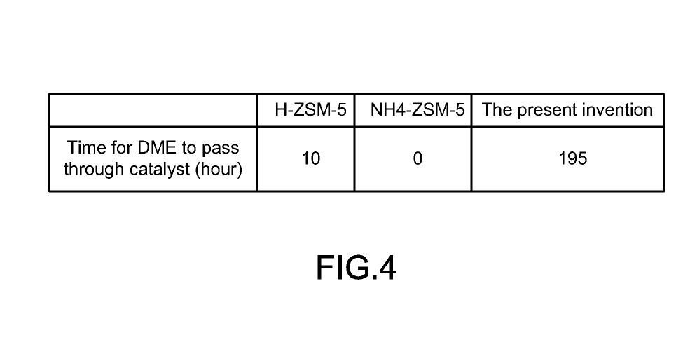

In FIG. 4, results of converting DME into gasoline with H-ZSM-5, NH₄-ZSM-5 and ZSM-5 prepared by our method are obtained (under a GHSV of dimethyl ether (DME) of 6.7 grams per gram of zeolite (g/g_zeolite), a reaction temperature of 300 Celsius degrees (° C.) and a reaction pressure of 1 bar). The pure NH₄-ZSM-5 has a very weak acidity because all of the acidic sites are occupied by the ammonium ions and the DME cannot be dehydrated for generating a hydrocarbon. Besides, the H-ZSM-5 is too acidic and makes dehydration of the oxygen-containing compound and the following reactions become too strenuous; and, so, carbon is rapidly deposited and life of the catalyst is severely shortened. However, the present invention uses ZSM-5, which keeps ammonium ions at strong-acid sites for forming a proper acidity to prolong life of the catalyst without reducing activity of the catalyst.

Hence, the present invention uses NH₃-TPD to obtain weak-acid and strong-acid temperatures of the catalyst 1a, where the ammonium form zeolite 1 is done through the thermo-process at a temperature higher than the temperature of the weak-acidic desorption and lower than that of the strong-acidic desorption; the ammonium ions at weak-acid sites are desorbed into ammonium molecules to change the zeolite 1 into a hydrogen-ion state; the ammonium ions at strong-acid sites are remained the same; and, thus, the ammonium form zeolite 1 obtains proper acidity for converting the oxygen-containing compound into the hydrocarbon. When the catalyst 1 loses activity on its surface owing to carbon deposits, the oxidizing gas 4 is directed in to remove the carbon deposits and regain activity through a high-temperature oxidation. If the temperature for the high-temperature oxidation is higher than that for the strong-acidic desorption, the ammonia gas 5 is directed in after the oxidation to replenish the lost ammonium ions at strong-acid sites. Thus, the ammonium form zeolite 1 is used as the catalyst 1a to dehydrate oxygen-containing compound for producing gasoline.

To sum up, the present invention is a zeolite catalyst for converting oxygen-containing compound into hydrocarbon, where an ammonium form zeolite is used as a catalyst to dehydrate oxygen-containing compound for producing gasoline; a thermo-process is used to change distribution of strong-acidic and weak-acidic sites of the ammonium form zeolite for prolonging life of the catalyst used in converting oxygen-containing compound into hydrocarbon.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A zeolite catalyst for converting oxygen-containing compound into hydrocarbon, comprising steps of:
(a) filling an ammonium form zeolite to a reactor; directing a gas to pressure said reactor, increasing a temperature of said reactor to a certain temperature degree, processing a weak-acidic desorption and a strong-acidic desorption to absorb ammonium ions at weak-acid sites and deammoniate said zeolite to form hydrogen ions to thus obtain a catalyst, modifying acidity of and activating said catalyst, and using said catalyst to dehydrate an oxygen-containing compound into a hydrocarbon, wherein said gas is selected from a group consisting of air and nitrogen gas; and,
(b) when a surface of said catalyst loses activity owing to carbon deposits, regenerating said catalyst through reactivating said catalyst by flowing an oxidizing gas to remove said carbon deposits through oxidation at a high temperature.

2. The catalyst according to claim 1, wherein, in step (a), a pressure of said reactor is increased for 1-10 bar with a gas hour space velocity (GHSV) maintained at 0-20 liters of gas per gram of zeolite (l_gas/g_zeolite) on directing said gas.

3. The catalyst according to claim 1,
wherein, in step (a), said ammonium form zeolite is done through a heat process at a temperature higher than a temperature of said weak-acidic desorption and lower than a temperature of said strong-acidic desorption; and said zeolite is changed into a hydrogen-ion state by desorbing said ammonium ions at said weak-acid sites while said ammonium ions at strong-acid sites are remained unchanged.

4. The catalyst according to claim 1,
wherein, in step (a), said temperature of said reactor is increased for 0.1˜48 hours (hrs).

5. The catalyst according to claim 1,
wherein, in step(b), said oxidizing gas is selected from a group consisting of oxygen and air.

6. The catalyst according to claim 1,
wherein, when a temperature of said catalyst is lower than a temperature of said strong-acidic desorption during regenerating said catalyst in step(b), said catalyst is directly dehydrated again after regenerating said catalyst.

7. The catalyst according to claim 1,
wherein, when a temperature of said catalyst is higher than a temperature of said strong-acidic desorption during said oxidation in step(b), said ammonium ions at strong-acid sites are decomposed and dispersed;
and, after an ammonia gas is directed to be absorbed by said catalyst after regenerating said catalyst, said catalyst is reactivated through step (a).

8. The catalyst according to claim 7,
wherein said ammonia gas has a GHSV of 0.1˜1 l_gas/g_zeolite and a concentration of 1˜10 weight percents (wt %) and is flown in for 0.1˜24 hrs.
